(19) United States
(12) Patent Application Publication
(10) Pub. No.: US 2010/0096538 A1
(43) Pub. Date: Apr. 22, 2010

(54) METHOD FOR MEASURING ANGULAR DISPLACEMENT USING OPTICAL FIBER AND METHOD FOR MANUFACTURING THE SAME

(76) Inventors: Jin-Sang Hwang, Suwon-si (KR); Jeong-Whan Lee, Chungju-si (KR)

Correspondence Address: STAAS & HALSEY LLP, SUITE 700, 1201 NEW YORK AVENUE, N.W., WASHINGTON, DC, 20005, US

(21) Appl. No.: 12/442,904

(22) PCT Filed: Sep. 28, 2006
(86) PCT No.: PCT/KR06/03875

§ 371 Date: Mar. 25, 2009

(51) Int. Cl. G01B 11/26

(52) U.S. Cl. 250/227.14; 250/236

(57) ABSTRACT

In a senor for measuring an angular displacement and a method for manufacturing the senor, the sensor includes an optical fiber and a detector. The optical sensor has a light source attached to a first end portion of the optical fiber for emitting light, and an exiting surface formed at a second end portion of the optical fiber. The detector has a photo sensor being attached to an end portion of the detector, for measuring a light's intensity. The exiting surface includes a first inclination surface being cut to have a predetermined angle along a first rotational direction of the optical fiber, and further includes a second inclination surface being cut to have a predetermined angle along a second rotational direction of the optical fiber. Therefore, manufacturing cost may be reduced and durability may be enhanced.

### CROSS-REFERENCE TO RELATED APPLICATIONS

This application claims the benefit of International Patent Application No. PCT/KR2006/003875, filed on Sep. 28, 2006, in the Korean Intellectual Property Office, the disclosure of which is incorporated herein in its entirety by reference.

### TECHNICAL FIELD

The embodiments discussed herein relate to a sensor for measuring an angular displacement and a method for manufacturing the sensor. More particularly, the embodiments relate to the sensor for measuring the angular displacement, decreasing manufacturing cost and enhancing durability, and the method for manufacturing the sensor.

### BACKGROUND ART

Human movement is defined by a displacement variation of a human body with respect to an applied force in a time or a space phase. In rehabilitation, when moving one's joints, indicating an angular displacement is important to examine one's medical state precisely. Generally, an angular sensor for indicating an angle is called as an inclination sensor, and the inclination senor measures an inclined angle of the human body with respect to a reference surface. Thus, measuring the inclined angle of one's joints respectively, is very difficult.

A sensor for measuring the inclined angle of one's joints has been developed. The sensor for measuring the inclined angle includes an angle sensor and a probe, and may measure an elbow, a knee and a hip joint. However, since the probe mechanically operates, the probe wears when repeatedly used. Therefore, the sensor for measuring the inclined angle having the probe, has a problem that repeatability of the sensor measurement gets worse as time goes on. In addition, manufacturing the probe precisely has a certain limitation, so that the sensor having the probe is hard to be minimized.

### DISCLOSURE

### Technical Problem

The embodiments provide a sensor for measuring an angular displacement using an optical fiber for decreasing manufacturing cost and enhancing durability.

The embodiments also provide a method for manufacturing the sensor for measuring the angular displacement.

### Technical Solution

In an example sensor for measuring an angular displacement according to the embodiments, the sensor includes an optical fiber and a detector. The optical fiber has a light source and an exiting surface. The light source is attached to a first end portion of the optical fiber for emitting light. The exiting surface is formed at a second end portion of the optical fiber. The light exits through the exiting surface. The detector has a photo sensor. The photo sensor is attached to an end portion of the detector, for measuring an intensity of the light exiting through the exiting surface. The exiting surface includes a first inclination surface being cut to have a predetermined angle along a first rotational direction of the optical fiber. The predetermined angle of the first inclination surface may be in a range between about 20 degrees and about 35 degrees.

The exiting surface may further include a second inclination surface being cut to have a predetermined angle along a second rotational direction of the optical fiber. The predetermined angle of the second inclination surface may be in the range between about 20 degrees and about 35 degrees. The second rotational direction may be perpendicular to the first rotational direction.

The sensor may further include a first cover having a first groove formed on an end portion of the first cover, for fixing and covering the optical fiber, a second cover having a second groove formed on an end portion of the second cover perpendicular to the first groove, for fixing and covering the detector, and a connecting rod for connecting the first cover to the second cover.

The light emitted from the light source may be internally reflected when passing through the optical fiber, so that the light totally exits through the exiting surface.

The connecting rod may include a first protrusion inserted into the first groove, and a second protrusion protruded perpendicular to the first protrusion and inserted into the second groove. The first cover may rotate around the first protrusion, and the second cover may rotate around the second protrusion. The rotational direction of the optical fiber may be the same as that of the first cover. The exiting surface may further include a second inclination surface being cut to have a predetermined angle along a rotational direction of the second cover. Each predetermined angle of the first and second inclination surfaces may be in the range between about 20 degrees and about 35 degrees.

The sensor may further include a cover portion that is attached around the connecting rod, for sealing the optical fiber and the detector.

In an example method for manufacturing a sensor for measuring an angular displacement according to the embodiments, the method includes attaching a light source emitting light to a first end portion of an optical fiber, and forming an exiting surface at a second end portion of the optical fiber, the light exiting through the exiting surface, and attaching a photo sensor measuring an intensity of the light exiting through the exiting surface to an end portion of a detector. The exiting surface includes a first inclination surface being cut to have a predetermined angle along a first rotational direction of the optical fiber.

The exiting surface may further include a second inclination surface being cut to have a predetermined angle along a second rotational direction of the optical fiber. The second rotational direction may be perpendicular to the first rotational direction. Each predetermined angle of the first and second inclination surfaces may be in a range between about 20 degrees and about 35 degrees.

The method may further include fixing and covering the optical fiber using a first cover having a first groove formed on an end portion of the first cover, fixing and covering the detector using a second cover having a second groove formed on an end portion of the second cover perpendicular to the first groove, and connecting the first cover to the second cover.

According to the embodiments, since the sensor includes the optical fiber, a light source and a photo sensor, the sensor may be manufactured with a simple structure and cost for manufacturing the sensor may be decreased.

In addition, the sensor measures the angular displacement using the intensity of the light detected by the photo sensor, when the light emitted from the light source exits from the exiting surface, so that durability of the sensor may be enhanced and the sensor may be minimized in comparison with the sensor that mechanically operates.

Furthermore, the exiting surface of the optical fiber may be cut to have a predetermined angle according to the number of the direction to be measured, so that multi-angular displacement may be measured using one sensor.

### BRIEF DESCRIPTION OF THE DRAWINGS

The above and other advantages of the embodiments will become more apparent by describing in detail exemplary embodiments thereof with reference to the accompanying drawings, in which:

FIG. 1 is an exploded perspective view illustrating a sensor for measuring an angular displacement according to an example embodiment;

FIG. 2 is a perspective view illustrating an assembled structure of the sensor in FIG. 1;

FIGS. 3 to 5 are plan views illustrating an advancing path of light exiting from an optical fiber;

FIG. 6 is a perspective view illustrating an exiting surface of the optical fiber of the sensor in FIG. 1;

FIG. 7 is a perspective view illustrating the sensor rotated by a predetermined angle around a rotation axis in FIG. 2; and

FIG. 8 is a graph showing a variation of a light's intensity according to an inclined angle of the exiting surface in FIG. 6.

FIG. 9 is a graph showing relations among the inclined angle of the exiting surface, the variation of the light's intensity and a measurement angle.

### BEST MODE FOR CARRYING OUT THE EMBODIMENTS

The embodiments are described more fully hereinafter with reference to the accompanying drawings, in which embodiments are shown. The embodiments may, however, be embodied in many different forms and should not be construed as limited to the embodiments set forth herein. Rather, these embodiments are provided so that this disclosure will be thorough and complete, and will fully convey the scope thereof to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the embodiments.

Unless otherwise defined, all terms (including technical and scientific terms) used herein have the same meaning as commonly understood by one of ordinary skill in the art to which the embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the embodiments will be described in detail with reference to the accompanying drawings.

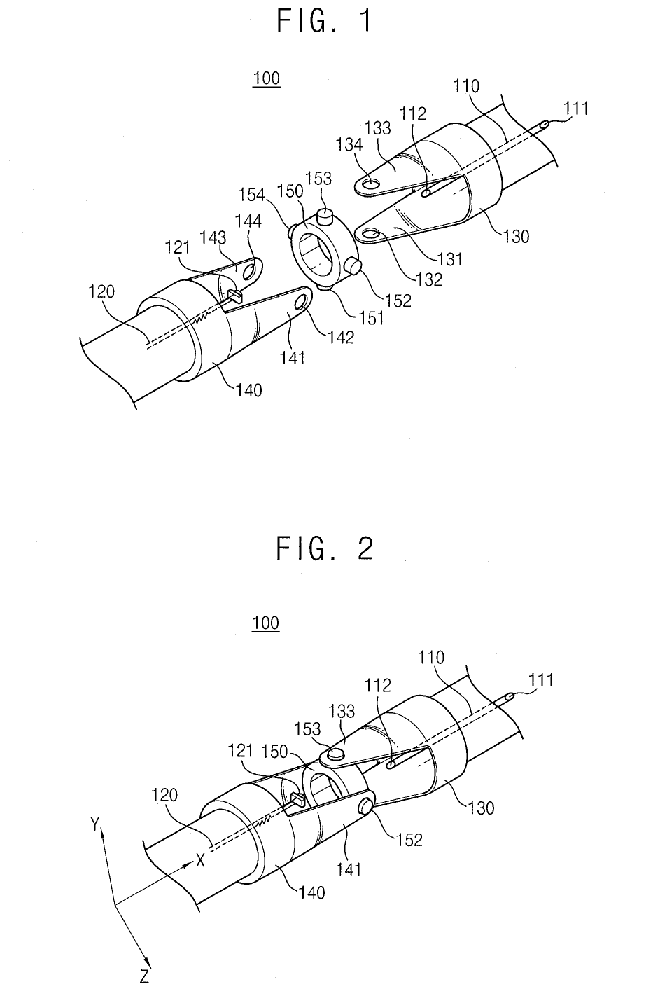

FIG. 1 is an exploded perspective view illustrating a sensor for measuring an angular displacement according to an example embodiment, and FIG. 2 is a perspective view illustrating an assembled structure of the sensor in FIG. 1.

Referring to FIGS. 1 and 2, the sensor 100 according to the present example embodiment includes an optical fiber 110, a detector 120, a first cover 130, a second cover 140 and a connecting rod 150.

The optical fiber 110 includes a light source 111 and an exiting surface 112. The light source 111 is attached to a first end portion of the optical fiber 110, for emitting light. The exiting surface 112 is attached to a second end portion of the optical fiber 110, and the light exits through the exiting surface 112. Particularly, the optical fiber 110 includes a first glass having a relatively higher refractive index in a center portion, and a second glass having a relatively lower refractive index in a peripheral portion covering the center portion, so that the total light passing through the optical fiber in the center portion is internally reflected. When the optical fiber 110 is used, since energy loss of the light passing through the optical fiber is very small, the light is hard to be lost and is not affected by an external effect. In the present example embodiment, the optical fiber 110 preferably has a cylindrical shape.

The light source 111 emits the light, and preferably includes a light emitting diode (“LED”). When the LED is used for the light source 111, power consumption may be decreased and energy efficiency may be enhanced.

The exiting surface 112 is formed at the second end portion of the fiber 110. The light emitted from the light source 111 exits through the exiting surface 112. Since the optical fiber 110 internally reflects the total light emitted from the light source 111, the light emitted from the light source 111 only exits through the exiting surface 112.

Therefore, the light is emitted from the light source 111 that is attached to the first end portion of the optical fiber 110, and is internally reflected passing through the optical fiber 110. Then, the light exits through the exiting surface 112 that is formed at the second end portion of the optical fiber 110.

The exiting surface 112 has a predetermined shape, and the shape will be explained in further descriptions.

The detector 120 includes a photo sensor 121. The photo sensor 121 is attached to an end portion of the detector 120, for measuring an intensity of the light exiting from the exiting surface 112. Particularly, the detector 120 is disposed to be separated from the exiting surface 112 of the optical fiber 110 by a predetermined distance. Thus, the detector 120 selectively absorbs the light exiting from the exiting surface 112, so that it may detect the intensity of the light. The predetermined distance between the detector 120 and the optical fiber 110 is preferably determined, considering the intensity of the light emitting from the light source 111, resolution of the detector 120, a size of the sensor 100, and so on.

For example, the photo sensor 121 for measuring the intensity of the light may include a photo transistor. The photo transistor is a light receiving type photo sensor, and is manufactured by combining a photo diode with a bipolar transistor. The photo transistor absorbs the light and generates a current and a voltage when the light is incident into a PN junction of a semiconductor. The photo transistor has a higher sensitivity, a longer life and a better reliability than the photo diode.

The first cover 130 fixes and covers the optical fiber 110. Since the optical fiber 110 is fixed to the first cover 130, the optical fiber 110 is constrained to the first cover 130 and moves together with the first cover 130. The first cover 130 may be manufactured to have a cylindrical shape like the optical fiber 110. The first cover 130 is formed to have a cylindrical groove inside, for fixing the optical fiber 110. Alternatively, the first cover 130 may be manufactured to have a various outside shape including a column shape. The first cover 130 covers the optical fiber 110, so that prevents the optical fiber 110 from an external impact or a contamination material.

First grooves 132 and 134 are formed at end portions 131 and 133 of the first cover 130, respectively. First protrusions 151 and 153 of the connecting rod 150 are inserted into and are fixed to the first grooves 132 and 134 respectively. In the present example embodiment, the end portion of the first cover 130 includes a U shape having two end portions 131 and 133. The first grooves 132 and 134 are formed at two end portions 131 and 133 respectively. Thus, when the first protrusions 151 and 153 are inserted into and fixed to the first grooves 132 and 134, the first cover 130 may rotate around the first protrusions 151 and 153. The end portion of the first cover 130 may be manufactured to have a various shape, so that the first cover 130 may rotate around a predetermined axis.

In the sensor 100 according to the present example embodiment, when the first cover 130 rotates around the predetermined axis with the optical fiber 110 fixed to the first cover 130, the photo sensor 121 detects the angular displacement of the first cover 130. Thus, the sensor 100 measures the angular displacement of the first cover 130.

The second cover 140 fixes and covers the detector 120. Since the detector 120 is fixed to the second cover 140, the detector 120 is constrained to the second cover 140 and moves together with the second cover 140. The second cover 140 may be manufactured to have the cylindrical shape like the first cover 130. The second cover 140 is formed to have a groove inside, for fixing the detector 120. Alternatively, the second cover 140 may be manufactured to have a various outside shape including the column shape. The second cover 140 covers the detector 120, so that prevents the detector 120 from the external impact or the contamination material.

Second grooves 142 and 144 are formed at end portions 141 and 143 of the second cover 140, respectively. Second protrusions 152 and 154 of the connecting rod 150 are inserted into and are fixed to the second grooves 142 and 144 respectively. In the present example embodiment, the end portion of the second cover 140 includes the U shape having two end portions 141 and 143. The second grooves 142 and 144 are formed at two end portions 141 and 143 respectively. Thus, when the second protrusions 152 and 154 are inserted into and fixed to the second grooves 142 and 144, the second cover 140 may rotate around the second protrusions 152 and 154.

The end portion of the second cover 140 may be manufactured to have a various shape, so that the second cover 140 may rotate around a predetermined axis. In this case, the rotation of the second cover 140 around the second protrusions 152 and 154 has the same meaning as the relative rotation of the first cover 130 around the second protrusions 152 and 154.

In the sensor 100 according to the present example embodiment, when the second cover 140 rotates around the predetermined axis with the detector 120 fixed to the second cover 140, the photo sensor 121 detects the relative angular displacement of the first cover 130. Thus, the sensor 100 measures the angular displacement of the second cover 140.

In this case, a direction along the second protrusions 152 and 154 is perpendicular to the direction along the first protrusions 151 and 153. Thus, a rotational direction of the first cover 130 is perpendicular to the rotational direction of the second cover 140. For example, when the first protrusions 151 and 153 are formed perpendicular to the second protrusions 152 and 154, a first surface on which the first cover 130 rotates is perpendicular to a second surface on which the second cover 140 rotates. Therefore, an arbitrary position of three dimensions may be expressed by the angular displacement of the first cover 130 and the angular displacement of the second cover 140.

The connecting rod 150 may include the cylindrical shape. Alternatively, the connecting rod 150 may include a various shape such as the column shape, according to the shape of the first and second covers 130 and 140. As mentioned above, the first and second protrusions 151, 152, 153 and 154 are formed on a surface of the connecting rod 150 and are protruded by a predetermined distance. The first grooves 132 and 134 of the first cover 130 are inserted into and are fixed to the first protrusions 151 and 153. The second grooves 142 and 144 of the second cover 140 are inserted into and are fixed to the second protrusions 152 and 154. Thus, the connecting rod 150 connects the first cover 130 to the second cover 140.

In addition, the first protrusions 151 and 153 are preferably perpendicular to the second protrusions 152 and 154. The first and second protrusions 151, 152, 153 and 154 perpendiculars to each other, fix the first surface and the second surface perpendicular to each other. The first cover 130 rotates on the first surface, and the second cover 140 rotates on the second surface. Thus, the arbitrary position of three dimensions may be expressed.

Referring to FIG. 2 again, the assembled structure of the sensor 100 including the first cover 130, the second cover 140 and the connecting rod 150 is illustrated. According to the present example embodiment, the first cover 130 rotates around a Y axis, and the second cover 140 rotates around a Z axis. For example, the first protrusions 151 and 153 are protruded along the Y axis, and the second protrusions 152 and 154 are protruded along the Z axis. An X axis is perpendicular to the Y axis and the Z axis, and the X axis is defined in parallel with an advancing direction of the light emitting from the light source 111 in the optical fiber 110.

For example, the light exiting through the exiting surface 112 of the optical fiber 110 enters into the photo sensor 121 of the detector 120. In this case, the connecting rod 150 includes an opening portion in a center portion, so that the light exiting from the exiting surface 112 may enter into the photo sensor 121. For example, the connecting rod 150 has the cylindrical shape having the opening portion in the center portion of the connecting rod 150. The connecting rod 150 may have the various shapes such as the column shape, but the center portion should be open.

In the present example embodiment, the first cover 130 rotating around the Y axis and the second cover 140 rotating around the Z axis have been explained. Alternatively, the first cover 130 fixing the optical fiber 110 and the second cover 140 fixing the detector 120 may rotate around one of the X, Y and Z axes.

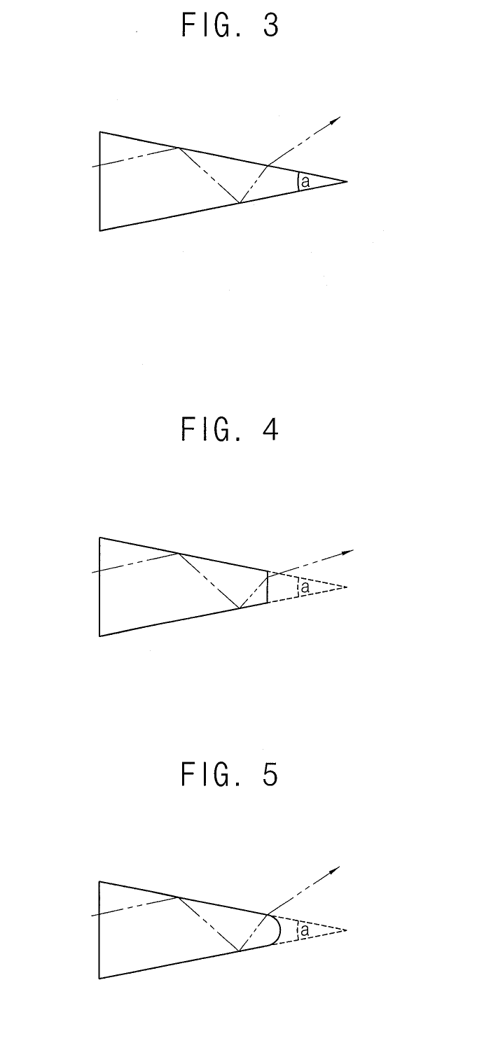

FIGS. 3 to 5 are plan views illustrating an advancing path of light exiting from an optical fiber.

Referring to FIGS. 3 to 5, an advancing path of the light exiting from the exiting surface changes according to a shape of the exiting surface of the optical fiber. In FIGS. 3 to 5, all the exiting surface has a conical shape, and the advancing path of the light is illustrated. Particularly, the advancing path of the light, when the exiting surface has the conical shape with a sharp end, is illustrated in FIG. 3. The advancing path of the light, when the exiting surface has the conical shape with a flat end, is illustrated in FIG. 4. The advancing path of the light, when the exiting surface has the conical shape with a rounded end, is illustrated in FIG. 5.

Generally, when the light advances from a first material to a second material, referring to the Snell's law, since a velocity of the light in the first material is different from that in the second material, the light refracts to a direction of the material having the larger refractive index. Thus, when the light advances from the first material to the second material, the refracted direction of the light may be changed by changing an angle between an advancing direction of the light and a dividing surface of the first and second materials.

Referring to FIGS. 3 to 5 again, when the exiting surface has the conical shape with the flat end as illustrated in FIG. 4, the light exits to a relatively smaller area. However, when the exiting surface has the conical shape with the sharp end or the rounded end as illustrated in FIG. 3 or 5, the light exits to a relatively larger area.

For example, the exiting area of the light is larger in the exiting surface having the conical shape with the sharp or rounded ends than in the exiting surface having the conical shape with the flat end. Thus, an end portion of the exiting surface is machined to have the conical shape with the sharp or rounded end, so that the sensor that measures a larger range of angular displacement may be manufactured.

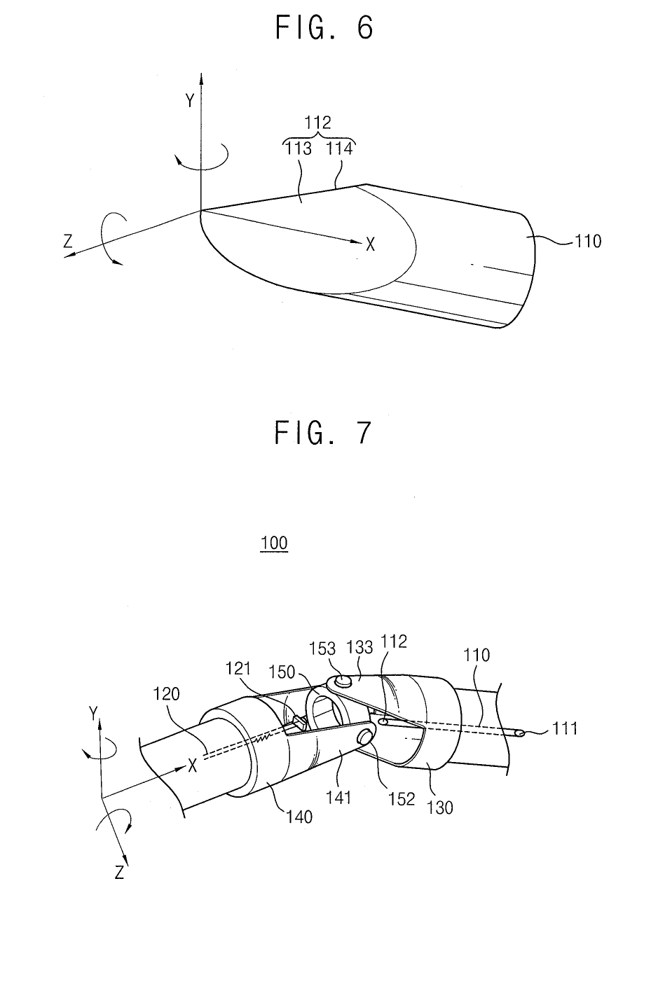

FIG. 6 is a perspective view illustrating an exiting surface of the optical fiber of the sensor in FIG. 1.

Referring to FIG. 6, the exiting surface 112 of the optical fiber 110 according to the present example embodiment includes a first inclination surface 113, and may further include a second inclination surface 114. Since the sensor 100 according to the present example embodiment may rotate around two rotation axes perpendicular to each other, the exiting surface 112 may include the first and second inclination surfaces 113 and 114. However, when the sensor 100 is manufactured to rotate around one rotation axis, the exiting surface 112 may include one of the first and second inclination surfaces 113 and 114.

To measure the larger range of angular displacement, the exiting surface 112 is preferably machined to have the conical shape with the sharp or rounded end. In the present example embodiment, the exiting surface 112 having the conical shape with the sharp end will be explained.

As the coordinate axis as illustrated in FIG. 2, the Y axis direction is parallel with the protruded direction of the first protrusions 151 and 153. The X axis is perpendicular to the Y axis and the Z axis, and is in parallel with the advancing direction of the light emitted from the light source 111 in the optical fiber 110. For example, the first cover 130 rotates around the Y axis, and the second cover 140 rotates around the Z axis.

The first inclination surface 113 is formed to have a predetermined angle along the rotational axis of the first cover 130. For example, the first inclination surface 113 is formed to have the predetermined angle with respect to a XY plane. Thus, when the first cover 130 combined with the optical fiber 110 rotates around the Y axis, the sensor 100 according to the present example embodiment may measure the larger range of angular displacement. In this case, the first inclination surface 113 is preferably formed to have the predetermined angle between about 20 degrees and about 35 degrees with respect to the XY plane. More detailed explanations follow below.

The second inclination surface 114 is formed to have a predetermined angle along the rotational axis of the second cover 140. For example, the second inclination surface 114 is formed to have the predetermined angle with respect to a ZX plane. Thus, when the second cover 140 combined with the detector 120 rotates around the Z axis (In this case, the first cover 130 combined with the optical fiber 110 relatively rotates around the Z axis), the sensor 100 according to the present example embodiment may measure the larger range of angular displacement. In this case, the second inclination surface 114 is preferably formed to have the predetermined angle between about 20 degrees and about 35 degrees with respect to the ZX plane. More detailed explanations follow below.

Referring to FIG. 6 again, the first inclination surface 113 is formed along a positive Z axis, and the second inclination surface 114 is formed along a positive Y axis. However, although not shown in the figure, the first inclination surface 113 may be formed along a negative Z axis, and the second inclination surface 114 may be formed along a negative Y axis.

Thus, the light emitted from the light source 111 exits into the relatively larger area through the first and second inclination surfaces 113 and 114, so that the sensor 100 according to the present example embodiment may measure the larger range of angular displacement.

FIG. 7 is a perspective view illustrating the sensor rotated by a predetermined angle around a rotation axis in FIG. 2.

Referring to FIG. 7, the first cover 130 combined with the optical fiber 110 rotates around the Y axis by a first rotation angle, and around the Z axis by a second rotation angle. In this case, the photo sensor 121 detects the intensity of the light that is emitted from the light source 111 and exits through the first inclination surface 113, so that measures the first rotation angle of the first cover 130 around the Y axis. In addition, the photo sensor 121 also detects the intensity of the light that is emitted from the light source 111 and exits through the second inclination surface 114, so that measures the second rotation angle of the first cover 130 around the Z axis.

As mentioned above, the end portions of the first and second covers 130 and 140 are formed to have the U shape. Thus, when the first and second covers 130 and 140 are connected to the connecting rod 150, the optical fiber 110 and the detector 120 may be partially exposed to an exterior. When the optical fiber 110 and the detector 120 are exposed to the exterior, the detector 120 may be affected by an external light source and the contamination material such as dust may be flowed in. To avoid the above problems, a cover portion (not shown) is attached around the connecting rod 150, so that seals the optical fiber 110 and the detector 120. Thus, the optical fiber 110 and the detector 120 are prevented from being exposed to the exterior.

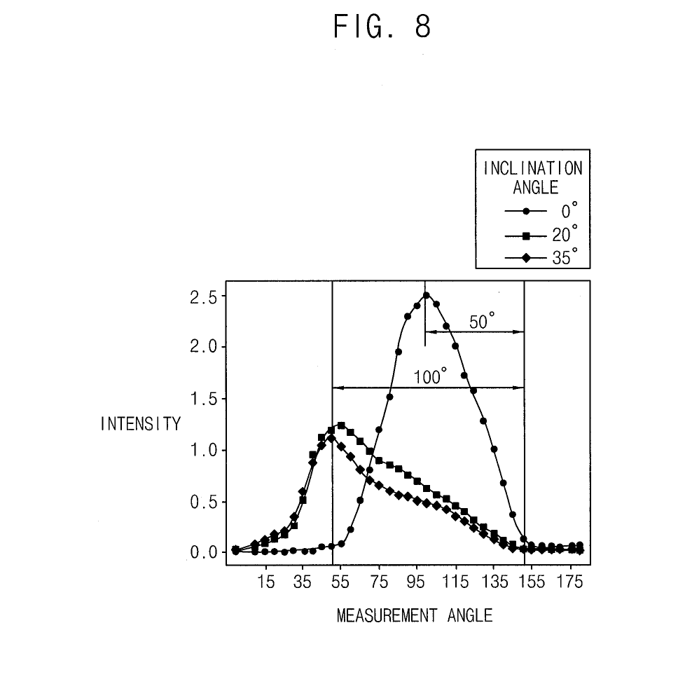

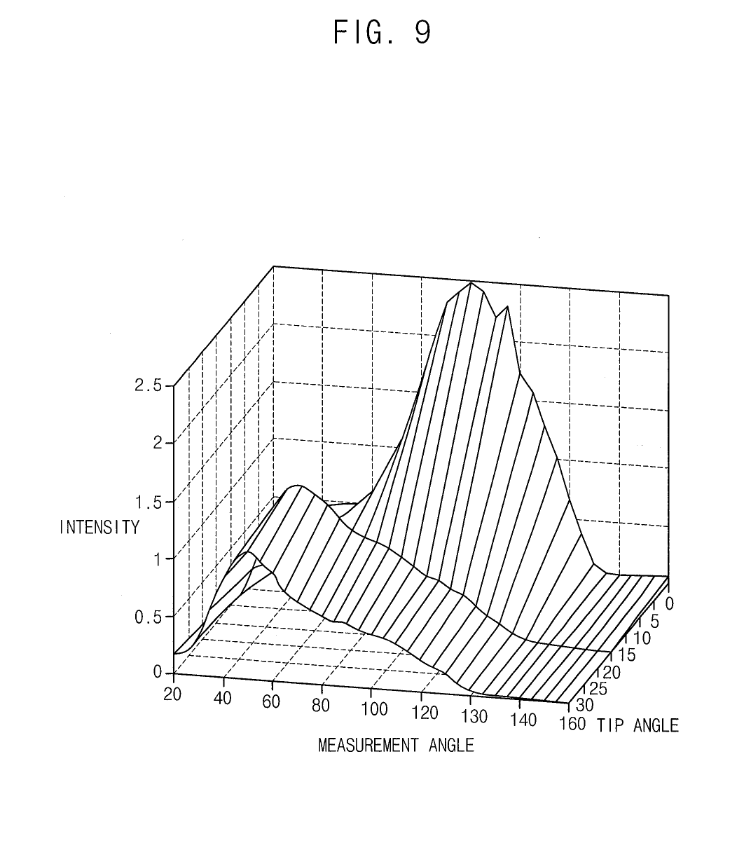

FIG. 8 is a graph showing a variation of a light's intensity according to an inclined angle of the exiting surface in FIG. 6, and FIG. 9 is a graph showing relations among the inclined angle of the exiting surface, the variation of the light's intensity and a measurement angle.

To investigate relation between the intensity of the light and the inclination angle, the photo transistor is used for the photo sensor 121, and 5 voltages are applied to the photo transistor. The LED is used for the light source 111, and 1.8 voltages are applied to the LED.

Referring to FIGS. 8 and 9, when the inclination angle of the exiting surface 112 is 0 degree, a variation of the intensity of the light measured by the photo sensor 121 follows Gaussian Distribution. However, when the inclination angle of the exiting surface 112 is about 25 degrees or about 35 degrees, the variation of the intensity of the light measured by the photo sensor 121 follows an asymmetric distribution. For example, a peak point of the distribution shifts to the left. The exiting area is smaller with the inclination angle of 0 degree than with the inclination angle of about 20 degrees or about 35 degrees. Thus, the maximum intensity of the light is lager with the inclination angle of 0 degree than with the inclination angle of about 20 degrees or about 35 degrees. However, in the sensor 100, the distribution of the intensity of the light is more important factor than the maximum intensity of the light.

Particularly, a range in which the distribution of the intensity of the light is linearly changed, is necessary for the sensor 100 to measure the angular displacement. With the inclination of the exiting surface 112 being 0 degree, the distribution of the intensity is linearly increased when a measurement angle is in the range between about 55 degrees and about 100 degrees, and the distribution of the intensity is linearly decreased when the measurement angle is in the range between about 100 degrees and about 155 degrees.

However, when the measurement angle is in the range between about 55 degrees and about 100 degrees, and in the range between about 100 degrees and about 155 degrees, the intensity of the light is overlapped. Therefore, the measurement angle in the range between about 100 degrees and about 155 degrees, is preferably used for the sensor 100 to measure the angular displacement. For example, the range in which the distribution of the intensity of the light is linearly decreased, is preferably used.

With the inclination of the exiting surface 112 being about 20 degrees or about 35 degrees, the distribution of the intensity is linearly increased when the measurement angle is in the range between about 35 degrees and about 55 degrees, and the distribution of the intensity is linearly decreased when the measurement angle is in the range between about 55 degrees and about 155 degrees. Therefore, the measurement angle in the range between about 55 degrees and about 155 degrees, is preferably used for the sensor 100 to measure the angular displacement.

For example, when the inclination angle of the exiting surface 112 is 0 degree, the sensor 100 may measure the angular displacement in the range between about 100 degrees and about 155 degrees. When the inclination angle of the exiting surface 112 is about 20 degrees or about 30 degrees, the sensor 100 may measure the angular displacement in the range between about 55 degrees and about 155 degrees. Therefore, when the inclination angle of the exiting surface 112 is formed to have about 20 degrees or about 35 degrees, the sensor 100 may measure a larger range of angular displacement. Although not shown in the figure, when the inclination angle is in the range between about 20 degrees and about 35 degrees, the intensity of the light is linearly decreased in the range of the measurement angle between about 55 degrees and about 155 degrees. Therefore, the inclination angle of the exiting surface 112 is preferably in the range between about 20 degrees and about 35 degrees.

Having described the example embodiments and their advantage, it is noted that various changes, substitutions and alterations can be made herein without departing from the spirit and scope as defined by appended claims.

### INDUSTRIAL APPLICABILITY

According to the embodiments, a sensor for measuring an angular displacement and a method for manufacturing the sensor, can be applied to a sensor for measuring the angular displacement of rehabilitation machine and a robot, a sensor for correcting a sports' posture, a motion sensor for yoga, model and virtual reality, and an unconstrained motion sensor.

1. A sensor for measuring an angular displacement, the sensor comprising:
a light source;
an optical fiber coupled to the light source and having an exiting surface, the light source attached to a first end portion of the optical fiber for emitting light, the exiting surface formed at a second end portion of the optical fiber; and
a detector is disposed to be separated from the optical fiber and measures an intensity of a light exiting through the exiting surface,
wherein the optical fiber transmits the light from the light source to the exiting surface along a fiber axis and the exiting surface forming a inclination surface inclined at a predetermined angle with respect to the fiber axis, and
wherein the detector measures an relative angular displacement between the optical fiber and the detector.

2. The sensor of claim 1, wherein the inclination surface has a one inclined surface and the predetermined angle of the inclined surface is between about 20 degrees and about 35 degrees.

3. The sensor of claim 1, wherein the inclination surface has a first inclined surface and a second inclined surface,
wherein the predetermined angle of the first inclined surface and the second inclined surface is between about 20 degrees and about 35 degrees, respectively.

4. The sensor of claim 3, wherein the second inclined surface is perpendicular to the first first inclined surface.

5. The sensor of claim 1, further comprising:
a first cover covering and fixing the optical fiber;
a second cover covering and fixing the detector; and
a connecting rod disposed between the first cover and the second cover and connects the first cover to the second cover.

6. The sensor of claim 5,
wherein the first cover has at least one first groove formed on an end portion of the first cover and the second cover has at least one second groove formed on an end portion of the second cover and the connecting rod has at least two protrusions corresponding to at least one first groove and at least one two groove, respectively to connect the first cover to the second cover.

7. The sensor of claim 5, wherein the light emitted from the light source is internally reflected when passing through the optical fiber, so that the light exits through the exiting surface.

8. The sensor of claim 6, wherein the first groove is positioned perpendicularly to the first protrusion the second protrusion is positioned perpendicularly to the first protrusion.

9. The sensor of claim 7, wherein the first cover rotates around the first protrusion, and the second cover rotates around the second protrusion.

10. The sensor of claim 9, wherein the rotational direction of the optical fiber is the same as that of the first cover.

11. The sensor of claim 5, further comprising a cover portion attached around the connecting rod to seal the optical fiber and the detector.

12. An angular displacement sensor, comprising:
an optical fiber emitting light from an end surface inclined with respect to a fiber axis of the fiber; and
a light detector rotatable with respect to the fiber and measuring an intensity of the light as the fiber rotates with respect to the detector.

13. The sensor of claim 12, wherein the inclined end surface has a one inclined surface and the predetermined angle of the inclined surface is between about 20 degrees and about 35 degrees.

14. The sensor of claim 13, wherein the inclined end surface has two inclined surfaces and the predetermined angles of the two inclined surface are between about 20 degrees and about 35 degrees, respectively

15. The sensor of claim 12, further comprising:
a first cover covering the optical fiber;
a second cover covering the light detector; and
a connecting rod disposed between the first cover and the second cover and connects the first cover to the second cover.

16. The sensor of claim 15, further comprising a cover portion attached around the connecting rod to seal the optical fiber and the detector.
